(19) United States
(12) Patent Application Publication
(10) Pub. No.: US 2013/0173371 A1
(43) Pub. Date: Jul. 4, 2013

(54) ENHANCING SERVICES FOR AWARD AIRLINE TICKETS

(71) Applicant: Mark J. Krolick, Naperville, IL (US)

(72) Inventor: Mark J. Krolick, Naperville, IL (US)

(73) Assignee: Mileage Plus Holdings, LLC, Chicago, IL (US)

(21) Appl. No.: 13/340,059

(22) Filed: Dec. 29, 2011

(51) Int. Cl. G06Q 30/02

(52) U.S. Cl. 705/14.23

(57) ABSTRACT

Some embodiments include a computer implemented method for providing enhanced services to an award ticket customer of an airline. The method can include selling, to the award ticket customer, an airline ticket in exchange for loyalty currency, wherein the selling occurs via an electronic website; and transmitting an electronic request for a business offer from a business partner of the airline, wherein the business offer is redeemable by the award ticket customer, and wherein the electronic request identifies contact information for the award ticket customer.

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2011, Mileage Plus Holdings, LLC.

### FIELD

Embodiments of the inventive subject matter relate generally to the field of data processing and more particularly to the field of enhancing airline travel experiences.

### BACKGROUND

Many airlines have loyalty programs. Such loyalty programs typically award loyalty program members with frequent-flier miles (also referred to as “loyalty miles”, “miles”, “points”, etc.) when members purchase airline tickets, and other goods and services. Members can redeem the frequent-flier miles for additional airline tickets, rental cars, hotel stays, and more. Thus, frequent-flier miles are like “credits” for use in purchasing airline tickets, and other goods and services. Typically, frequent-flier miles are only redeemable at one airline (i.e., the airline that awarded the miles). As members accrue and redeem miles with a particular airline, the members typically develop loyalty to that airline. As a result, airline loyalty programs are constantly looking for new and creative ways to award and redeem frequent-flier miles.

### BRIEF DESCRIPTION OF THE FIGURES

The present invention is illustrated by way of example and not limitation in the Figures of the accompanying drawings in which:

FIG. 1 is a conceptual diagram illustrating transactions between a loyalty program, its customers, and its business partners.

FIG. 2 is a block diagram illustrating computerized components, according to embodiments of the invention.

FIG. 3 is flow diagram operations for booking award tickets, according to some embodiments of the inventive subject matter.

FIG. 4 is a block diagram illustrating operations for delivering special offers to award ticket customers, according to some embodiments of the inventive subject matter.

FIG. 5 is a block diagram illustrating operations for providing enhanced services for award ticket customers.

FIG. 6 is a block diagram illustrating operations for providing enhanced services based on information and/or offers obtained from business partners.

FIG. 7 is a block diagram showing some embodiments of a loyalty program server.

FIG. 8 depicts a more detailed view of an example loyalty program server, according to some embodiments of the inventive subject matter.

### DESCRIPTION OF THE EMBODIMENTS

### Introduction

Airline loyalty programs may award loyalty currency (e.g., miles) when customers purchase airline tickets and make other loyalty program transactions. Customers may redeem the loyalty currency for airline tickets and/or merchandise. Some airlines refer to airline tickets purchased with loyalty currency as award tickets. Many airline loyalty program customers take their most important trips using award tickets. For example, after accruing miles over years of business travel, a customer may redeem the miles for a family vacation and other special trip. Because customers spend considerable resources accruing miles with one particular airline, they often feel entitled to special treatment on their award ticket trips. Unfortunately, many airlines do not provide special treatment for award customers. In some instances, airlines may not have facilities for providing special treatment to award passengers. In other instances, airlines may view award tickets as financially burdensome (e.g., because the airline did not receive money for the tickets), thereby minimizing services for award travelers. In any case, many award travelers are unhappy with their award travel experience.

Some embodiments of the inventive subject matter enable airlines to provide enhanced travel experiences for award ticket customers. In some embodiments, airline loyalty programs operate with business partners to provide special offers, such as goods and/or services, to award ticket customers. For example, an airline loyalty program may request that a partner rental car company offer special discounts to particular award ticket customers. In other embodiments, airlines may identify award ticket customers and provide upgrades and perks during the travel experience. For example, airline computers may identify award ticket customers, and give them priority boarding, preferred seating, discounted bag fees, free drinks, free in-flight Wi-Fi, etc. As award travelers progress through various touch points (e.g., baggage check-in, gate check-in, in-flight Wi-Fi, etc.), the airlines can provide special perks to award travelers. Some embodiments enable airlines to use special branding for all award travel correspondence, so travelers associate award travel with special treatment.

### Loyalty Currency Transactions

As noted above, embodiments of the inventive subject matter enhance travel experiences for award travelers. In some instances, airline loyalty programs work with business partners to provide such enhanced travel experiences. In other embodiments, the airlines themselves provide enhanced service to award travelers. Before discussing details about how the embodiments provide enhanced travel experiences, this discussion will describe how loyalty currency is utilized by different entities.

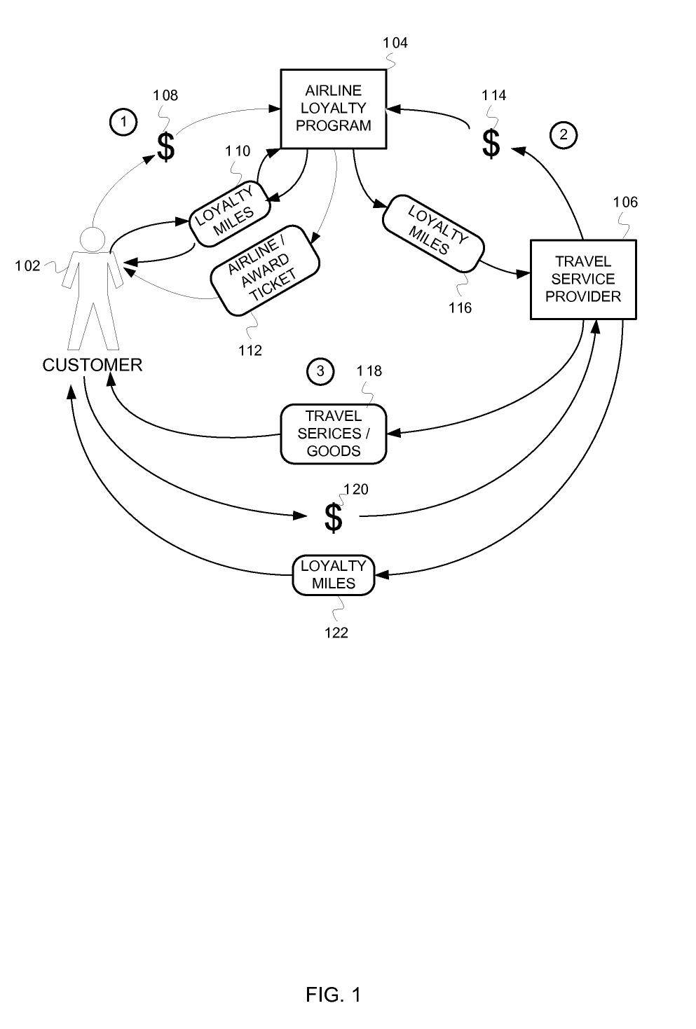

FIG. 1 is a conceptual diagram illustrating transactions between a loyalty program, its customers, and its business partners. FIG. 1 shows a customer 102, airline loyalty program 104, and business partner 106. The airline loyalty program 104 can be associated with an airline, such as United Airlines, Inc. The business partner 106 is a business partner of the airline loyalty program, and can be a rental car provider, hotel operator, tour operator, retailer, etc.

Transactions between the airline loyalty program 104 and customers 102 involve an exchange of money, airline tickets, and loyalty miles. As shown, the customer 102 pays money 108 to the airline loyalty program 104 in exchange for an airline ticket 112. For each purchase, the airline loyalty program 104 may award loyalty miles 110 to the customer 102. In other transactions, the customer 102 can redeem the loyalty miles 110 for award tickets 112. The customer can also redeem the loyalty miles 110 for various goods and services, such as rental car services, hotel services, merchandise, etc. Although not shown, the airline loyalty program 104 may provide an electronic interface (e.g., a website) through which the customer 102 can purchase tickets and conduct other transactions. The airline loyalty program 104 may also maintain electronic accounts for each customer, where the accounts keep track of loyalty miles that have accrued, airline tickets purchases, award ticket purchases, money spent, and other information associated with such transactions. Furthermore, the airline loyalty program 104 may be capable of receiving monies (108) from credit card companies and other electronic payment facilities.

FIG. 1 also shows transactions between the airline loyalty program 104 and a business partner 106. In FIG. 1, the airline loyalty program 104 sells loyalty miles 116 to the business partner 106 for money 114. The business partner 106 can use the loyalty miles 116 to entice customers to buy its travel goods and services. For example, the customer 102 can purchase travel services 118 for money 120. As part of the transaction, the travel service provider 106 awards loyalty miles 122 to the customer 102. In some instances, the business partner 106 may offer significant discounts or additional loyalty miles to award travelers. As a result, award travelers will recognize they are receiving special treatment.

This discussion continues with a description of some components that may be used to provide enhanced experiences for award ticket customers.

### System Components

This section describes an example operating environment and provides structural aspects of some embodiments. After describing some example system components, this section will describe more details about how the system components operate.

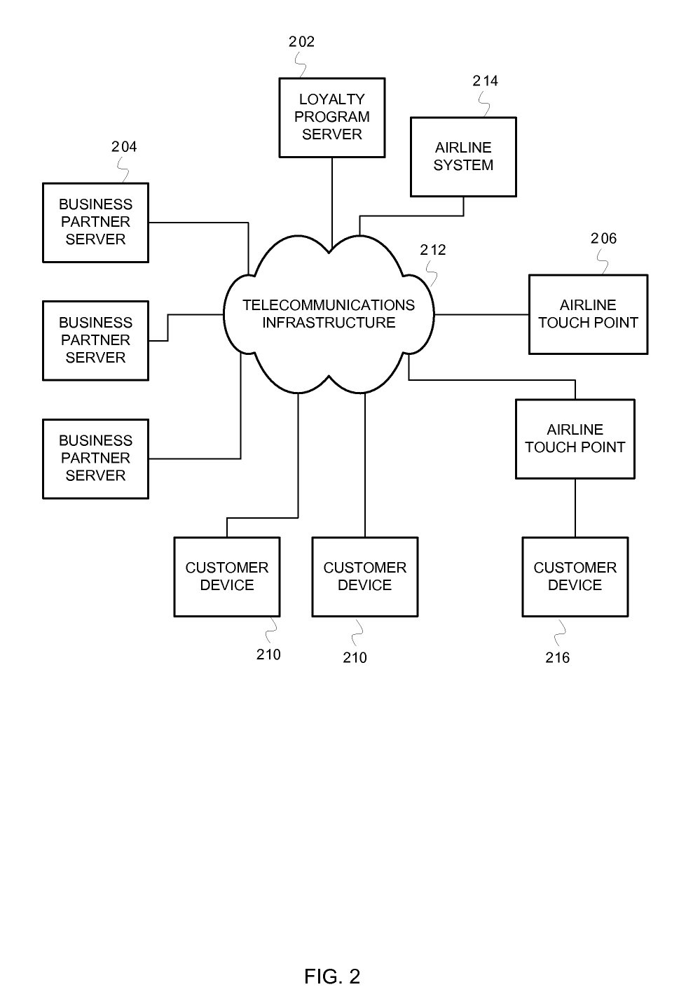

In some embodiments, a loyalty program operates one or more computers that conduct transactions and interact with other entities via a telecommunications network. FIG. 2 is a block diagram illustrating computerized components, according to embodiments of the invention. FIG. 2 shows a loyalty program server 202 connected to a telecommunications infrastructure 212. The telecommunications infrastructure 212 can include a local area network (LAN) or a wide area network (WAN). The telecommunications infrastructure 212 and connections to it can include any suitable technology, such as Public Switched Telephone Network (PSTN), Ethernet, 802.11g, SONET, WiFi, etc.

In FIG. 2, the telecommunications infrastructure 212 is also connected to business partner servers 204, an airline system 214, airline touch points 206 (also referred to as touch point devices), and customer devices 210. As shown, a consumer device 216 can connect with the airline touch point 206 (e.g., using blue tooth, Wi-Fi, etc.).

In operation, the loyalty program server 202 can process transactions for goods and services, and transactions that redeem and award loyalty currency. For example, the loyalty program server 202 can book airline tickets for cash, and it can book award tickets for loyalty currency. The loyalty program server 202 can also maintain customers' loyalty currency accounts. Additionally, the loyalty program server 202 can process transactions with the business partner servers 204. Such transactions can include contacting business partner servers 204 as part of processes for enhancing award ticket services. In some instances, the business partner servers 204 respond with business offers (e.g., discounts, free merchandise, free services, more favorable service terms, etc.) for award ticket customers.

The business partner servers 204 can process transactions for the sale of goods and services. In some instances, the business partner servers 204 provide electronic interfaces (e.g., web pages) that facilitate transactions with customers via the customer devices 210. In some instances, the business partner servers 204 process transactions involving offers that were made to award ticket customers.

The airline system 214 includes components (not shown) for processing airline customer information and moving travelers to their destinations. In some embodiments, the airline system 214 includes components that process reservations, baggage check-in, flight schedules, etc. The airline system 214 operates with the airline touch points 206 to provide enhanced services for award ticket travelers. The airline touch points 206 include components that interact with award travelers. Airline touch points 206 can include flight check-in kiosks (at airport), ticket scanners (e.g., at airport gate), in-flight sales devices, in-flight WiFi servers, etc. The airline system 214 can include one or more databases that include information about award tickets. In some embodiments, the airline system 214 can identify the award tickets, select enhanced services for the award tickets (e.g., priority boarding, discount bag check fees, free in-flight WiFi, etc.), and deliver the services via the airline touch points 206.

For simplicity, FIG. 2 shows a limited number of components. In practice, there may be any suitable number of loyalty program servers, airline systems, and other components. The components shown in FIG. 2 may be sub-divided, and can include mainframes, minicomputers, personal computers, laptops, cell phones, personal digital assistants, and any other suitable computing devices.

### Booking Award Tickets

This discussion will continue with a description of operations performed by some embodiments of the components described above. Some embodiments book award tickets, and then take measures to provide enhanced services for award travelers. The following process will describe how some embodiments book award tickets.

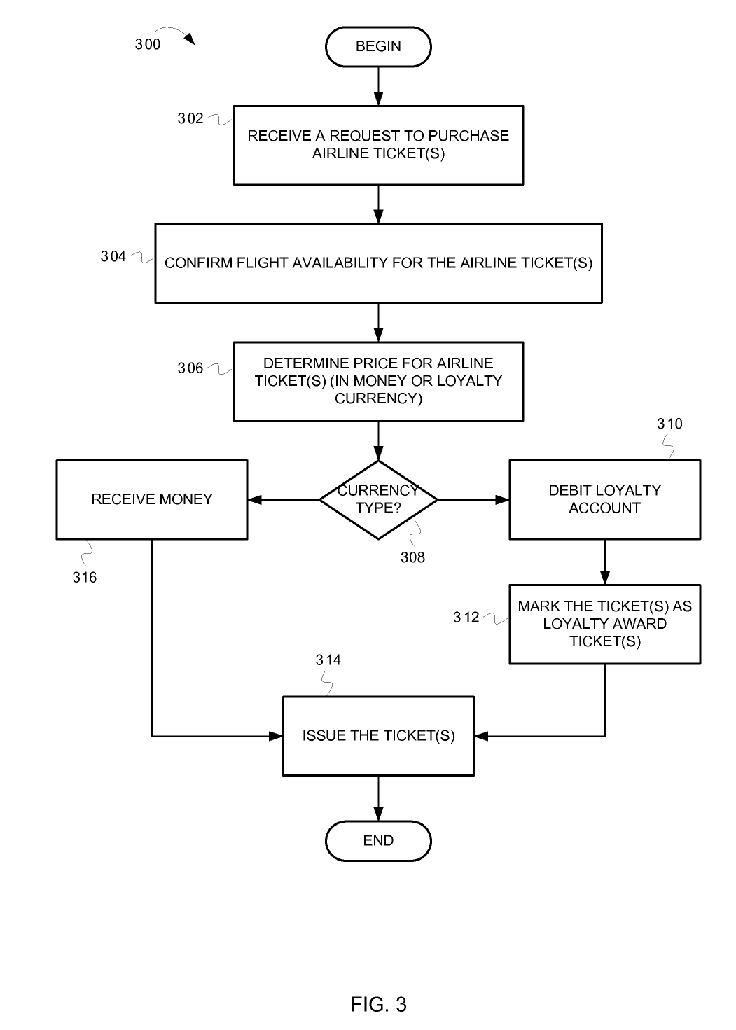

FIG. 3 is flow diagram operations for booking award tickets, according to some embodiments of the inventive subject matter. In some embodiments, a loyalty program server performs operations shown in FIG. 3. However, in some embodiments, the loyalty server may communicate with airline computers (e.g., an airline system 214) or other components as part of the operations of FIG. 3. For simplicity, such communications are not described in FIG. 3.

In FIG. 3, a flow 300 begins at block 302, where a loyalty program server receives a request to purchase one or more airline tickets. In some embodiments, the request is received from a customer device, such as a personal computer connected to the Internet. The flow continues at block 304.

At block 304, the loyalty program server confirms flight availability for the airline tickets. In some instances, the loyalty program server may contact other components (e.g., an airline system) to confirm availability for the airline tickets. The flow continues at block 306.

At block 306, the loyalty program server determines a price for the airline ticket(s). Loyalty program customers can pay for airline tickets with money or loyalty currency. After determining a price, the loyalty program server can present price information to the customer.

At block 308, the loyalty program server determines whether the customer will pay for the ticket(s) with money or loyalty currency. If the customer will pay with money, the flow continues at block 316, where the loyalty program server receives money from the customer. Although not shown, some embodiments operate with third-party payment systems, such as credit card processing systems, online payment systems, etc. From block 316, the flow continues to block 314.

Referring back to block 308, if the customer will pay with loyalty currency, the flow continues at block 310. At block 310, the loyalty program server debits the customer's loyalty currency account in an amount equal to the price for the ticket(s). Next, (at block 312) the loyalty program server marks the ticket(s) as “award ticket(s).” Marking makes the award tickets identifiable by processes that select award tickets for various upgrades and enhancements. As noted above, award tickets are airline tickets that were purchased using loyalty currency. Finally, (at block 314) the loyalty server issues the tickets.

After the operations in FIG. 3, a loyalty program server can identify award tickets, and perform operations for enhancing travel services for the award ticket travelers. The following section describes numerous ways embodiments can provide enhanced travel experiences for award ticket travelers.

### Enhancing Award Travel

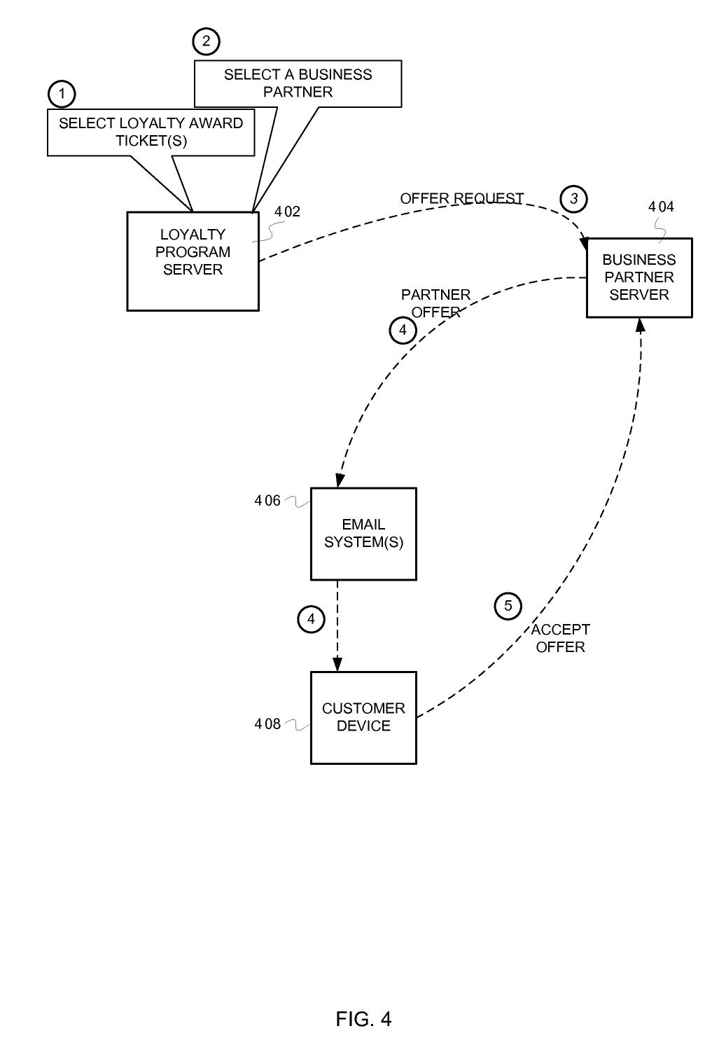

This section presents details about how embodiments can enhance services for award tickets. In some instances, airline loyalty programs can enhance services by directing business partners to offer special services to award ticket customers. FIG. 4 is a block diagram illustrating operations for delivering special offers to award ticket customers, according to some embodiments of the inventive subject matter. In FIG. 4, a loyalty program server 402 works with a business partner server 404, and an e-mail system 406. In FIG. 4, operations occur in 5 stages.

During stage 1, the loyalty program server 402 selects one or more award tickets. In some instances, the loyalty program server 402 selects award tickets for flights within a particular date range. In other instances, selection may be based on other criteria, such as customer loyalty status (e.g., number of miles flow with the airline), customer preferences, availability of business partner offers, etc. After selecting one or more award tickets, the server 402 selects a business partner who will provide offers to customers associated with the award tickets (see stage 2).

During stage 3, the loyalty program server 402 transmits offer requests to the business partner server 404. In some embodiments, the offer request includes contact information (e.g., e-mail addresses) for award ticket customers. In some embodiments, the offer request can include (or identify) branding information indicating logos and/or other branding content to be used when corresponding with award ticket customers. Because the loyalty program server provides (or identifies) branding information, the business partner server 404 can include logos and branding content in e-mails and other content.

During stage 4, the business partner server 404 transmits business offers to the award ticket customers. The business offers can include discounts for services (e.g., rental car, hotel, tours, digital services, etc.), discounts for merchandise (e.g., travel products, digital products), free services, free goods, etc. As shown, in some embodiments, the business partner server 404 transmits business offers to e-mail addresses associated with award ticket customers. The award ticket customers can use personal computers or other devices (customer device 408) to access e-mail offers. In some embodiments, the e-mails include web links with which award ticket customers can redeem the offers. As noted above, e-mails can include branding information. Such branding may help associate the special offers with award tickets, thereby establishing a perception that award travel offers special treatment.

During stage 5, the award ticket customers redeem the offers. For example, the award ticket customer may activate a web link (e.g., a uniform resource locator) that initiates a process for redeeming the offer via the Internet. In other embodiments, award ticket customers may utilize information included in the e-mail to redeem the offer at a bricks-and-mortar store or facility.

Although not shown, the loyalty program server 402 can receive a confirmation message indicating that the business partner server 404 sent a business offer to the award ticket customer. Similarly, the server 402 may receive a message indicating that the award ticket customer accepted the business partner's offer.

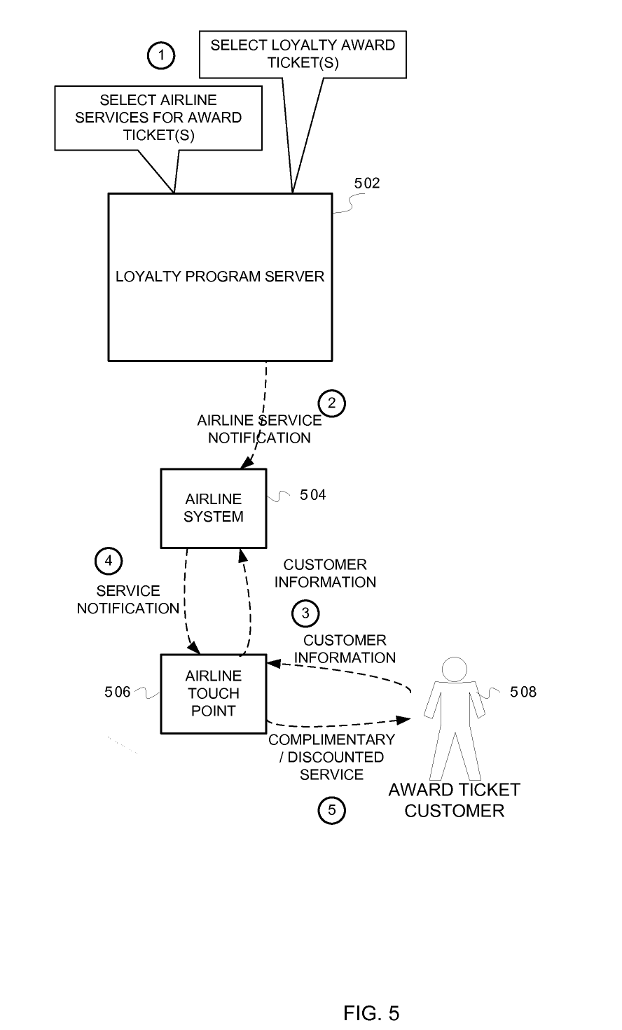

By performing the operations of FIG. 4, the loyalty program engages business partners to provide award ticket customers with special offers that may not be available for non-award ticket customers. FIG. 5 shows embodiments that do not engage business partners. Instead of engaging business partners to assist in providing enhanced services, some embodiments enable the airline itself to enhance award ticket services. This discussion continues with a description of FIG. 5.

FIG. 5 is a block diagram illustrating operations for providing enhanced services for award ticket customers. In FIG. 5, a loyalty program server 502 works in concert with an airline system 504, and an airline touch point 506. As noted above, the airline touch point 506 can be a baggage check-in kiosk, flight check-in kiosk, ticket scanner (e.g., at the airport gate), in-flight point-of-sale system, in-flight media system, access to lounges, etc. FIG. 5 shows operations occurring in five stages.

During stage 1, the loyalty program server 502 selects one or more loyalty award tickets for which enhanced services will be provided. Additionally, during stage 1, the server 502 selects services for the award tickets. Enhanced services can include priority check-in, priority boarding, priority seating, discounted bag check fees, complementary in-flight food and/or drink, complementary in-flight movie, etc.

During stage 2, the loyalty program server 502 notifies the airline system 504 about the selected award tickets and service enhancements. For example, the loyalty program server may transmit a message indicating that a particular ticket should receive discounted bag check fees, priority boarding, and complementary in-flight champagne. The airline system 504 records this information in a database associated with award ticket service enhancements.

During stage 3, an award ticket customer 508 provides customer information to the airline touch point 506. For example, the award ticket customer 508 may enter ticket information at a flight check-in kiosk. As another example, the award ticket customer 508 may provide customer information to an in-flight point-of-sale system (e.g., system for selling in-flight media access, food and drink, etc.). The customer information can include a unique identifier associated with the award ticket, information identifying the customer, or any other suitable information. In turn, the airline touch point 506 forwards the customer information, and any other information necessary for providing services, to the airline system 504.

During stage 4, the airline system 504 determines (e.g., based on receipt of the customer information) there are enhanced services to be delivered to the award ticket customer 508, and returns a service notification to the airline touch point 506. The service notification can identify an award ticket customer and servers to deliver to the customer.

During stage 5, the airline touch point 506 provides the service enhancement indicated in the service notification. For example, at baggage check-in, the airline touch point 506 provides a discounted bag check fee to the customer. As another example, at a flight check-in kiosk, the kiosk can: print a boarding pass designated for priority boarding, provide a selectable seat upgrade options, solicit selections for complementary in-flight food and/or drink, etc. As a result, embodiments provide enhanced services to award ticket customers.

In some embodiments, the airline touch point 506 displays particularized branding information which associates the service upgrades with award tickets. For example, the touch point 506 may present particular logos and content on video display devices and printed material.

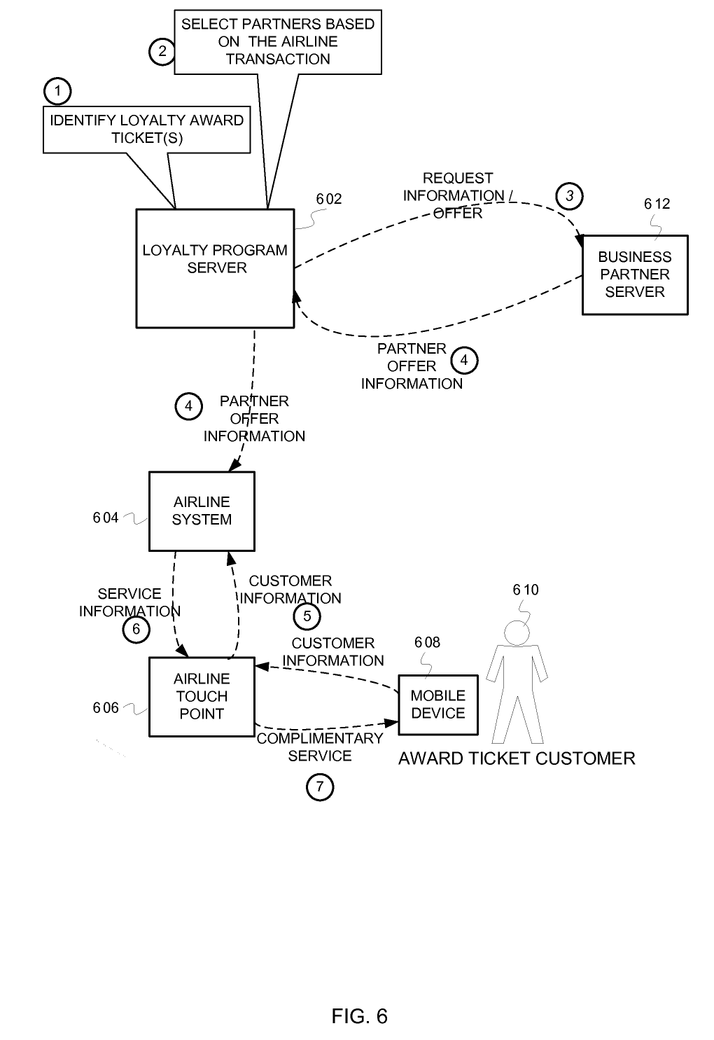

This discussion continues with more techniques for providing enhanced services to award ticket customers. Some embodiments enable airlines to query business partners for information about award ticket customers, and then utilize the information to provide enhanced travel services. FIG. 6 describes such an embodiment.

FIG. 6 is a block diagram illustrating operations for providing enhanced services based on information and/or offers obtained from business partners. In FIG. 6, a loyalty program server 602 works in concert with an airline system 604, airline touch point 606, mobile device 608, and business partner server 612. In FIG. 6, operations occur in seven stages.

During stage 1, the loyalty program server 602 selects one or more award tickets. In some instances, the loyalty program server 602 selects award tickets for flights within a particular date range. In other instances, selection is based on other criteria, such as loyalty status (i.e., number of miles accrued with the airline), customer preferences, availability of business partner offers, etc. After selecting one or more award tickets, the server 602 selects a business partner who will provide information and/or offers to award ticket customers (see stage 2). Business partner selection may be based on loyalty status, loyalty customer preferences, availability of business partner offers, etc.

During stage 3, the loyalty program server 602 requests information and/or offers for the award ticket customers. Some business partners may have information about award ticket customers. For example, a media provider (e.g., Netflix) may have a relationship with one or more of the award ticket customers. Hence, the media provider may have information indicating the award ticket customers' favorite movies, songs, and other media. Additionally, the media provider may offer a free movie to the award ticket customer. In some instances, the business partner can be a restaurant, hotel, rental car company, retailer, etc. The information can include information about customer preferences, such as food, drink, media, cars, etc. The business partner information can also include information about customers' mobile devices, buying habits, etc. In some instances, the offer is redeemable when the customer is in-flight. In other instances, the offer is redeemable at various airline touch points.

During stage 4, the business partner server 612 provides the offer and/or customer information to the loyalty program server 602. In turn, the loyalty program server 602 forwards the information to the airline system 604.

During stage 5, the award ticket customer 610 uses a mobile device 608 to interact with the airline touch point 606. As part of the interaction, the mobile device 608 transmits information identifying the award ticket customer 610 to the airline touch point 606. In turn, the touch point 606 forwards the information to the airline system 604. In some embodiments, stage 5 occurs in-flight. For example, the award ticket customer 610 may attempt to use an in-flight Wi-Fi network (provided by touch point 606). As part of a process for accessing Wi-Fi network, the mobile device 608 may provide a ticket number or other identifier identifying the award ticket customer 610. The touch point 606 forwards the ticket number to the airline system 604.

During stage 6, using the ticket number or other identifier, the airline system 604 determines that it has a business offer or information for enhancing services for the customer 610. In turn, the airline system 604 transmits the offer and/or service information to the touch point 606. Offers may enable free or discounted services, whereas information may help tailor services for the award ticket customer 610.

During stage 7, the touch point 606 provides services. For example, after receiving offer information, the touch point 606 may allow the mobile device 608 to access free Wi-Fi services. In some instances, the Wi-Fi service may be limited to media provided by the business partner server 610 (or its affiliated components), require that the customer 610 view advertisements of the business partner, etc. As another example, a free service may be limited to downloading a particular movie from the business partner server 612. As noted above, the business partner server 612 may send customer information without sending an offer. The airline system 604 can use the customer information to select complimentary food, drinks, media, or other services provided by the airline. As a result, the airline can provide an enhanced level of service to award ticket passengers.

Some embodiments can execute the operations shown in FIG. 6 without a mobile device. For example, the business partner server 612 may offer a free bottle of champagne, as part of a campaign to promote its champagne product. If the business partner has a relationship with one or more award ticket holders, it may offer a champagne product preferred by ticketholders. While in flight, an airline touch point 606 (e.g., a handheld point-of-sale system) may instruct a flight attendant to deliver a bottle of complementary champagne to the customer 610. Therefore, some embodiments can perform the operations of FIG. 6 to provide enhanced in-flight award ticket services with help from business partners.

### More System Components

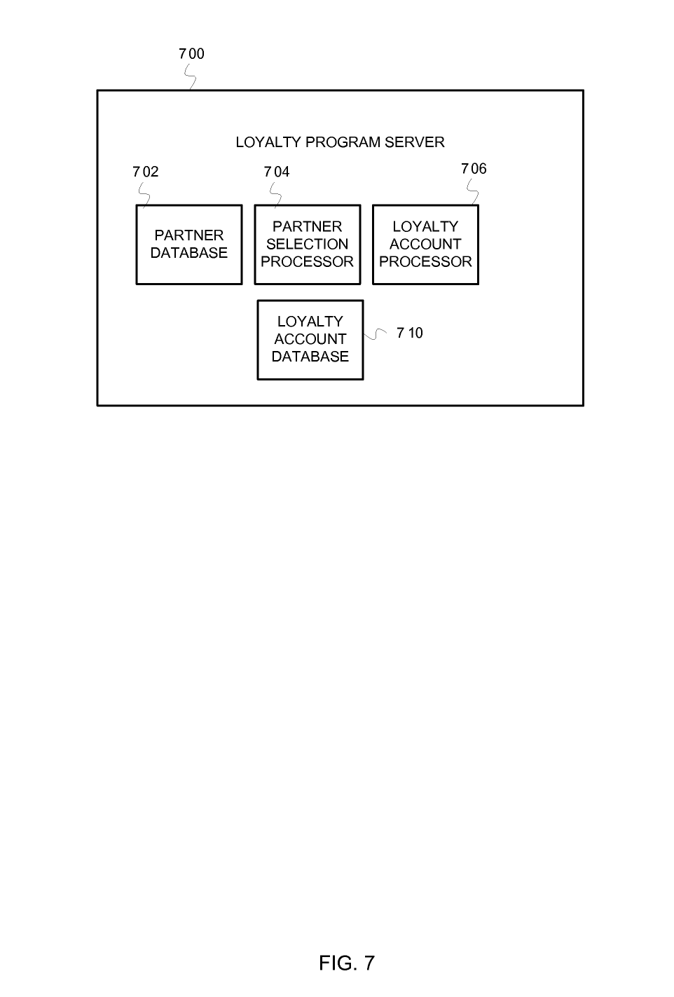

FIG. 7 is a block diagram showing some embodiments of a loyalty program server. In FIG. 7, the loyalty program server 700 includes a partner database 702, partner selection processor 704, loyalty account processor 706, and loyalty account database 710.

The partner selection processor 704 can select partners that may have product offerings for award ticket customers. In some embodiments, the partner selection processor 704 can utilize the partner database 702.

The loyalty account processor 706 can credit and debit loyalty currency in accounts associated with loyalty program customers and partners (e.g., see discussion of operations for loyalty currency redemption in FIG. 2). The loyalty account database 710 stores account information.

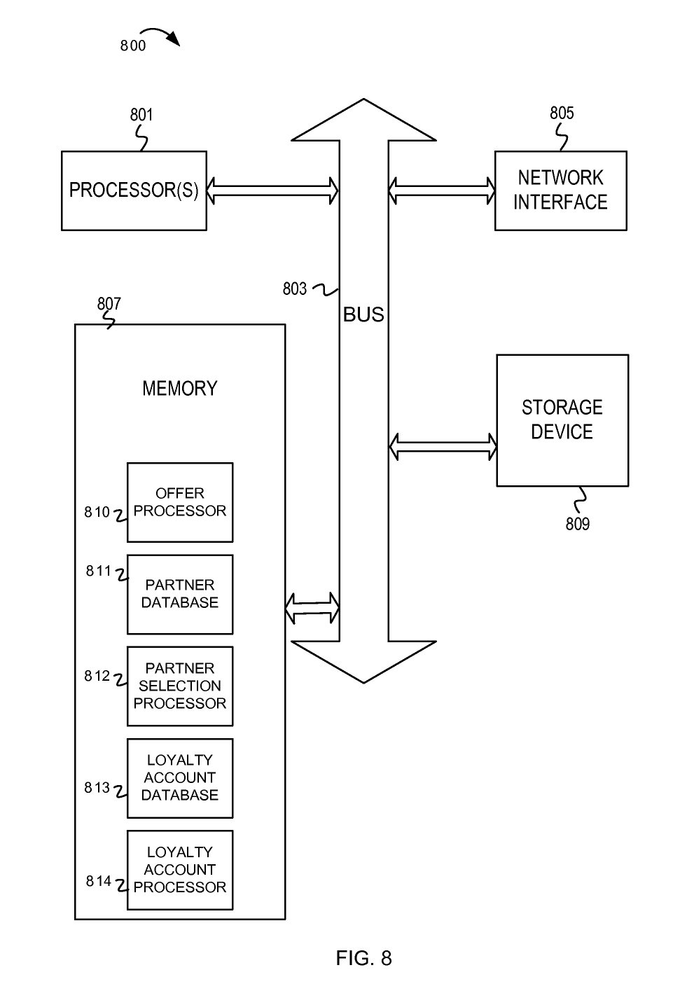

FIG. 8 depicts a more detailed view of an example loyalty program server, according to some embodiments of the inventive subject matter. In FIG. 8, the server includes a processor unit 801 (possibly including multiple processors, multiple cores, multiple nodes, and/or implementing multi-threading, etc.). The computer system includes memory 807. The memory 807 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media.

The computer system also includes a bus 803 (e.g., PCI, ISA, PCI-Express, HyperTransport®, InfiniBand®, NuBus, etc.), a network interface 805 (e.g., an ATM interface, an Ethernet interface, a Frame Relay interface, SONET interface, wireless interface, etc.), and a storage device(s) 809 (e.g., optical storage, magnetic storage, etc.). The system memory 807 embodies functionality to implement embodiments described above. The memory includes a partner database 810, partner selection processor 811, loyalty account processor 812, offer processor 813, and loyalty account database 814. Any one of these components may be partially (or entirely) implemented in hardware and/or on the processing unit 801. For example, the operations may be implemented with an application specific integrated circuit, in logic implemented in the processing unit 801, in a co-processor on a peripheral device or card, etc. Further, realizations may include fewer or additional components not illustrated in FIG. 8 (e.g., video cards, audio cards, additional network interfaces, peripheral devices, etc.). The processor unit 801, the storage device(s) 809, and the network interface 805 are coupled to the bus 803. Although illustrated as being coupled to the bus 803, the memory 807 may be coupled to the processor unit 801.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

While the embodiments are described with reference to various implementations and exploitations, it will be understood that these embodiments are illustrative and that the scope of the inventive subject matter is not limited to them. In general, techniques described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

As discussed herein, aspects of the present inventive subject matter are described with reference to flowcharts and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In some embodiments, the operations described herein may be represented by instructions stored in a computer readable medium or a plurality of computer readable mediums. A computer readable medium includes a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

### Computer Readable Media

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

1. A computer implemented method for providing enhanced services to an award ticket customer of an airline, the computer implemented method comprising:
selling, to the award ticket customer, an airline ticket in exchange for loyalty currency, wherein the selling occurs via an electronic website; and
transmitting an electronic request for a business offer from a business partner of the airline, wherein the business offer is redeemable by the award ticket customer, and wherein the electronic request identifies contact information for the award ticket customer.

2. The computer implemented method of claim 1 further comprising:
receiving, from a computer operated by the business partner, information about the award ticket customer, wherein the information indicates preferences of the award ticket customer; and
selecting one or more service upgrades based on the information about the award ticket customer.

3. The computer implemented method of claim 1 further comprising:
receiving an electronic indication that the business partner transmitted the business offer to the award ticket customer.

4. The computer implemented method of claim 1 further comprising:
receiving another electronic confirmation indicating that the award ticket customer accepted the business offer.

5. The computer implemented method of claim 1, wherein the electronic request include information identifying branding information to appear in electronic communications with the award ticket customer.

6. The computer implemented method of claim 1, further comprising:
receiving, at an in-flight airline device, a request to redeem the business offer, wherein the request is received from a mobile device of the award ticket customer;
providing service associated with the business offer.

7. The computer implemented method of claim 5, wherein the service includes enabling access to in-flight media.

8. The computer implemented method of claim 5, wherein the service includes beverage service.

9. A computer program product for providing enhanced services to an award ticket customer of an airline, the computer program product comprising:
a computer readable storage medium having computer usable program code embodied therewith, the computer usable program code comprising a computer usable program code configured to:
sell to the award ticket customer, an airline ticket in exchange for loyalty currency, wherein the selling occurs via an electronic website; and
transmit an electronic request for a business offer from a business partner of the airline, wherein the business offer is redeemable by the award ticket customer, and wherein the electronic request identifies contact information for the award ticket customer;
receive from a computer operated by the business partner, information about the award ticket customer, wherein the information indicates preferences of the award ticket customer; and
select one or more service upgrades based on the information about the award ticket customer.

10. The computer program product of claim 9, wherein the program code is further configured to:
receive an electronic indication that the business partner transmitted the business offer to the award ticket customer.

11. The computer program product of claim 9, wherein the program code is further configured to:
receive another electronic confirmation indicating that the award ticket customer accepted the business offer.

12. The computer program product of claim 9, wherein the electronic request include information identifying branding information to appear in electronic communications with the award ticket customer.

13. The computer program product of claim 9, wherein the program code is further configured to:
receive, at an in-flight airline device, a request to redeem the business offer, wherein the request is received from a mobile device of the award ticket customer;
provide service associated with the business offer.

14. The computer program product of claim 9, wherein the service includes enabling access to in-flight media.

15. The computer program product of claim 9, wherein the service includes beverage service.

16. A system for enhancing in-flight services for award ticket customers, the system comprising:
a loyalty program server configured to book an airline ticket for an award customer in exchange for frequent flier miles, and to electronically procure an in-flight service offer from a business partner;
a touch point device located on an airplane, wherein the touch point device is configured to
detect information identifying the award customer;
notify the loyalty program server information identifying the award ticket customer;
receive information about the in-flight service offer; and
provide service associated with the in-flight service offer.

17. The system of claim 16, wherein the service associated with the in-flight service offer includes providing free Internet content to a computing device operated by the award ticket customer.

18. The system of claim 16, wherein provision of the service associated with the in-flight service offer includes presentation, on a display device of the touch point device, information directing a flight attendant to deliver a particular beverage to the award ticket customer.
